(19) United States
(12) Patent Application Publication
(10) Pub. No.: US 2003/0124261 A1
(43) Pub. Date: Jul. 3, 2003

(54) Olefinically unsaturated ether carboxylic acids and their use in emulsion polymerization

(75) Inventors: Uwe Falk, Bruchkobel (DE); Klaus Poellmann, Burghausen (DE); Hendrik Ahrens, Frankfurt am Main (DE)

Correspondence Address: Clariant Corporation, Industrial Property Department, 4000 Monroe Road, Charlotte, NC, 28205, US

(73) Assignee: Clariant GmbH

(21) Appl. No.: 10/323,097

(22) Filed: Dec. 18, 2002

(30) Foreign Application Priority Data
Dec. 21, 2001 (DE) 10163258.4

(51) Int. Cl. B05D 3/02

(52) U.S. Cl. 427/385.5

(57) ABSTRACT

Olefinically unsaturated ether carboxylic acids comprising compounds of the formula (1)

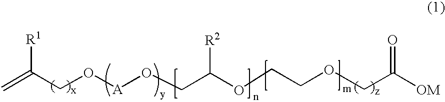

in which

R¹ is H or C₁-C₄-alkyl,

R² is methyl or ethyl,

A is an alkylene radical having 2 to 4 carbon atoms,

x is 0 or 1

y is 0 or 1

with the proviso that (x+y) is always 1

n is an integer from 0 to 100,

m is an integer from 0 to 1000,

with the proviso that (n+m) is greater than or equal to 1,

z is an integer from 1 to 6, and

M is hydrogen, an alkali metal ion or an ammonium ion

are useful in emulsion polymerization.

The present invention relates to novel allylpolyalkylene glycol ether carboxylates and vinylpolyalkylene glycol ether carboxylates and to their use as copolymerizable emulsifiers and hydrophilic monomers in emulsion polymerization.

In emulsion polymerization, olefinically unsaturated and water-insoluble monomers are dispersed in the form of micelles by emulsifiers in an aqueous medium. Free-radical formers then initiate the polymerization reaction, which takes place in the polymer particles formed in situ.

The emulsifiers used for the emulsion polymerization according to the prior art are mostly anionic and nonionic emulsifiers. These emulsifiers are bonded to the surface of the polymer particles by physical forces.

Customary anionic emulsifiers are sodium, potassium and ammonium salts of fatty acids, sodium alkylbenzenesulfonates, sodium alkylsulfonates, sodium olefinsulfonates, sodium polynaphthalenesulfonates, sodium dialkyldiphenyl ether disulfonates, sodium, potassium and ammonium alkyl sulfates, sodium, potassium and ammonium alkyl polyethylene glycol ether sulfates, sodium, potassium and ammonium alkylphenol polyethylene glycol ether sulfates, sodium, potassium and ammonium mono- and dialkyl sulfosuccinates and monoalkylpolyoxethyl sulfosuccinates, and alkylpolyethylene glycol ether phosphoric mono-, di- and triesters and mixtures thereof and alkylphenol polyethylene glycol ether phosphoric mono-, di- and triesters and mixtures thereof, and sodium, potassium and ammonium salts thereof.

The nonionic emulsifiers usually used are alkylphenol polyethylene glycol ethers, alkylpolyethylene glycol ethers, fatty acid polyethylene glycol ethers, ethylene/propylene glycol block polymers and sorbitan ester polyethylene glycol ethers.

The polymer particles which form in situ are stabilized by the emulsifiers used and prevented from coagulating.

An overview of customary processes, surfactants and further auxiliaries of emulsion polymerization is given by Peter A. Lovell and Mohamed S. El-Aasser, in “Emulsion Polymerization and Emulsion Polymers”, published by John Wiley and Sons, 1997.

In addition to the anionic and nonionic surfactants, during the polymerization it is also possible to use hydrophilic, water-soluble and olefinically unsaturated monomers which have at least one anionic group in the molecule for stabilizing the polymer particles. These hydrophilic water-soluble monomers include, for example:

olefinically unsaturated carboxylic acids, such as acrylic acid, methacrylic acid, crotonic acid and itaconic acid and their sodium, potassium and ammonium salts,

olefinically unsaturated polycarboxylic acids, such as maleic acid and fumaric acid and their sodium, potassium and ammonium salts

olefinically unsaturated sulfonic acids and their alkali metal and ammonium salts, such as acrylamidomethylpropanesulfonic acid and their alkali metal and ammonium, alkylammonium and hydroxyalkylammonium salts, allyl- and vinylsulfonic acid and their alkali metal and ammonium salts,

olefinically unsaturated phosphonic acids and their alkali metal and ammonium, alkylammonium and hydroxyalkylammonium salts, such as allylphosphonic acid, vinylphosphonic acid, acryloyloxethylphosphonic acid and their ammonium and alkali metal salts, and the corresponding methacrylic acid derivatives.

Water-insoluble monomers are, for example, the following:

vinyl monomers, such as carboxylic esters of vinyl alcohol, for example

vinyl acetate, vinyl propionate, vinyl ethers of isononanoic acid or of

isodecanoic acid, styrene and stilbene,

olefinically unsaturated carboxylic esters, such as ethyl acrylate, n-butyl acrylate,

isobutyl acrylate, hexyl acrylate, 2-ethylhexyl acrylate, hydroxyethyl acrylate,

and the corresponding methacrylic esters,

olefinically unsaturated amines, ammonium salts, nitriles and amides, such as

dimethylaminoethyl acrylate, acryloyloxethyltrimethylammonium halides,

acrylonitrile, N-methacrylamide, N-ethylacrylamide, N-propylacrylamide, and the corresponding methacrylic acid derivatives and vinylmethylacetamide,

olefins, such as ethylene, propene and butenes, pentene, 1,3-butadiene and chloroprene,

vinyl halides, such as vinyl chloride, vinylidene chloride and vinylidene fluoride.

The hydrophilic, water-soluble monomers react with the water-insoluble monomers, meaning that the anionic groups incorporated into the polymer particle contribute to the stabilization of the polymer particles because of electrostatic interactions. A disadvantage of the hydrophilic water-soluble monomers with one or more anionic groups is their good solubility in water, since they are as a result mainly in the aqueous phase and do not attach to the polymer particles in which the polymerization reaction takes place, but rather, as a result of free-radical homopolymerization in the aqueous phase, form readily water-soluble oligomers which do not contribute to the stabilization of the polymer particles.

Accordingly, it was an object of the present invention to find novel copolymerizable emulsifiers which can be used in emulsion polymerization. These emulsifiers should not have the above-described disadvantages of the hydrophilic monomers during the stabilization of the polymer particles. It should be possible with them to dispense with the stabilizing action of hydrophilic monomers.

### SUMMARY OF THE INVENTION

We have now found novel allyl- and vinylpolyalkyleneglycol ether carboxylates which can be prepared by the Williamson synthesis by reacting allyl- and vinylpolyalkyleneglycol ethers with monochloroalkanecarboxylic acids. Because of their ambivalent character, the novel allyl- and vinylpolyalkyleneglycol ether carboxylates attach to the surface of the polymer particles and can react with the olefinically unsaturated and water-insoluble monomers and be chemically incorporated into the polymer particles. Using the novel allyl- and vinylpolyalkyleneglycol ether carboxylates, it is possible to prepare stable and low-coagulation polymer dispersions.

The invention provides compounds of the formula (1)

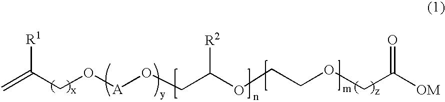

in which

R¹ is H or C₁-C₄-alkyl,

R² is methyl or ethyl,

A is an alkylene radical having 2 to 4 carbon atoms,

x is 0 or 1

y is 0 or 1

with the proviso that (x+y) is always 1

n is an integer from 0 to 100,

m is an integer from 0 to 1000,

with the proviso that (n+m) is greater than or equal to 1,

z is an integer from 1 to 6, and

M is hydrogen, an alkali metal ion or an ammonium ion.

The invention further provides for the use of the compounds according to the invention as polymerizable emulsifiers and hydrophilic monomers in emulsion polymerization.

The invention further provides a process for emulsion polymerization in which compounds of the formula 1 are subjected, together with one or more olefinically unsaturated monomers, to free-radical polymerization.

The compounds of the formula 1 can be used alone in suspension or emulsion polymerizations as emulsifier, and also in a mixture with anionic and/or nonionic surfactants which are known from the prior art.

The structural units

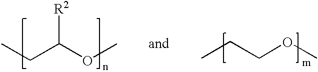

from formula (1) can be present as blocks in the order given in formula (1), as blocks in the opposite order to formula (1), and in random order. Preference is given to blocks.

R¹ is preferably a methyl or ethyl radical or hydrogen, in particular hydrogen.

R² is preferably a methyl group.

A is preferably an ethylene, butylene or propylene group, in particular an ethylene group or butylene group.

n is preferably a number from 2 to 50, in particular from 3 to 30.

m is preferably a number from 2 to 200, in particular from 3 to 100.

z is preferably a number from 2 to 4.

### DETAILED DESCRIPTION OF THE INVENTION

The allyl- and vinylpolyalkylene glycol ether carboxylates according to the invention can be introduced into the reaction vessel prior to the start of the polymerization reaction, or be added to the reaction vessel during the polymerization reaction.

In general, the compounds of the formula (1) according to the invention are used as emulsifiers and hydrophilic monomers in amounts of from 0.1 to 50% by weight, preferably 0.2 to 10% by weight, in particular 0.4 to 4% by weight, based on the weight of the water-insoluble or sparingly soluble monomers used for the preparation of the polymer dispersion.

The compounds according to the invention are suitable for the preparation of stable polymer dispersions. To prepare these polymer dispersions, unsaturated monomers are suitable with which the compounds according to the invention are polymerized. Suitable monomers are those compounds which have at least one olefinic double bond, which is substituted by hydrogen or one or more radicals, where these radicals may be hydrocarbon radicals or heteroatom-carrying hydrocarbon radicals which have 1 to 50 carbon atoms. Preferred olefinically unsaturated monomers are, for example,

vinyl monomers, such as carboxylic esters of vinyl alcohol, for example vinyl acetate, vinyl propionate, vinyl ethers of isononanoic acid or of isodecanoic acid,

aryl-substituted olefins, such as styrene and stilbene

olefinically unsaturated carboxylic esters, such as methyl acrylate, ethyl acrylate, propyl acrylate, n-butyl acrylate, isobutyl acrylate, pentyl acrylate, hexyl acrylate, 2-ethylhexyl acrylate, hydroxyethyl acrylate, and the corresponding methacrylic esters,

olefinically unsaturated dicarboxylic esters, such as dimethyl maleate, diethyl maleate, dipropyl maleate, dibutyl maleate, dipentyl maleate, dihexyl maleate and di-2-ethylhexylmaleate,

olefinically unsaturated carboxylic acids and dicarboxylic acids, such as acrylic acid, methacrylic acid, itaconic acid, maleic acid and fumaric acid and their sodium, potassium and ammonium salts,

olefinically unsaturated sulfonic acids and phosphonic acids and their alkali metal and ammonium salts, such as acrylamidomethylpropanesulfonic acid and their alkali metal and ammonium, alkylammonium and hydroxyalkylammonium salts, allylsulfonic acid and its alkali metal and ammonium salts, acryloyloxethylphosphonic acid and its ammonium and alkali metal salts, and the corresponding methacrylic acid derivatives,

olefinically unsaturated amines, ammonium salts, nitriles and amides, such as dimethylaminoethyl acrylate, acryloyloxethyltrimethylammonium halides, acrylonitrile, N-methylacrylamide, N-ethylacrylamide, N-propylacrylamide, N-methylolacrylamide and the corresponding methacrylic acid derivatives and vinylmethylacetamide.

In a preferred embodiment, the abovementioned monomers are polymerized with further comonomers, preferably olefins or halogenated olefins having 2 to 8 carbon atoms, such as, for example, ethylene, propene, butenes, pentenes, 1,3-butadiene, chloroprene, vinyl chloride, vinylidene chloride, vinylidene fluoride and tetrafluoroethylene.

The compounds according to the invention can be used either on their own or else in combination with other known anionic and nonionic emulsifiers of the prior art, as have been described at the beginning. The amount of the anionic and nonionic emulsifiers of the prior art is then preferably 0.001 to 5% by weight, in particular 0.01 to 1% by weight and particularly preferably 0.02 to 0.5% by weight, based on the weight of the water-insoluble or sparingly soluble monomers.

Further auxiliaries and additives for the use with the compounds according to the invention may be protective colloids, such as carboxymethylcellulose, hydroxyethylcellulose, methylhydroxypropylcellulose, and partially and completely saponified polyvinyl alcohol.

The polymer dispersions prepared using the novel allyl- and vinylpolyalkylene glycol ether carboxylates according to the invention are suitable for use as coatings for fabrics, as paper size in paper and board production, as binders for pigments and fillers in printing pastes for textiles, leather, papers, boards, and for coatings and paints for mineral surfaces, wood, metals and plastics and as adhesive raw material in adhesive formulations.

### EXAMPLES

The following examples illustrate the invention in more detail.

### Example 1

730 g of allylpolyalkylene glycol ether comprising 4 mol of propylene oxide and 10 mol of ethylene oxide were heated to 50° C. under a nitrogen atmosphere, and 160 g of monochloroacetic acid were added over the course of 10 minutes. 62 g of sodium hydroxide prills were added to the reaction mixture, with stirring, in 8 portions over the course of 2 hours at 50° C. The reaction mixture was then heated to 70° C. and held at this temperature for 2 hours. Cooling gave 952 g of the sodium allylpolyalkylene glycol ether carboxylate.

### Example 2

473 g of vinylpolyalkylene glycol ether, an addition product comprising 4-hydroxybutyl vinyl ether with 4 mol of propylene oxide and 10 mol of ethylene oxide were heated to 50° C. under a nitrogen atmosphere, and 96 g of monochloroacetic acid were added over the course of 10 minutes. 37 g of sodium hydroxide prills were added to the reaction mixture, with stirring, in 8 portions over the course of 2 hours at 50° C. The reaction mixture was then heated to 70° C. and held at this temperature for 2 hours. Cooling gave 606 g of the sodium salt of the vinylpolyalkylene glycol ether carboxylic acid.

### Example 3

The macromonomer from example 2 was used as coemulsifier in the emulsion polymerization of styrene, n-butyl acrylate, methyl methacrylate and methacrylic acid. The copolymer of styrene, n-butyl acrylate, methyl methacrylate and methacrylic acid and the macromonomer from example 2 which forms in situ has, on the basis of its ambivalent structure, good emulsion-stabilizing properties.

358 ml of water were introduced into a glass flask and 8 g of ®Emulsogen EPA 073 (sodium alkyl ether sulfate), 37 g of a 3.75% strength ammonium peroxodisulfate solution, 9 g of styrene, 12.5 g of n-butyl acrylate, 6 g of methyl methacrylate and, 0.3 g of methacrylic acid were added and the mixture was stirred. With stirring, the emulsion was heated to 80° C. and a monomer emulsion which consisted of 625 ml of water, 28 g of Emulsogen EPA 073, 22 g of the macromonomer from example 2, 350 g of styrene, 512 g of n-butyl acrylate, 234 g of methyl methacrylate, 10.7 g of methacrylic acid and 4.2 g of ammonium peroxodisulfate was metered in over 3 hours. Following complete metered addition of the monomer emulsion and an after-polymerization of one hour at 80° C., the polymer dispersion was cooled to room temperature and adjusted to pH 7-8 with ammonia solution.

### Example 4

The macromonomer from example 1 was used as coemulsifier in the emulsion polymerization of n-butyl acrylate, methyl methacrylate and methacrylic acid. The copolymer of n-butyl acrylate, methyl methacrylate and methacrylic acid and the macromonomer from example 1 which forms in situ has, on the basis of its ambivalent structure, good emulsion-stabilizing properties.

520 ml of water were introduced into a glass flask, and 16 g of ®Emulsogen EPA 073 (sodium alkyl ether sulfate), 15 g of a 3.75% strength ammonium peroxodisulfate solution, 11.8 g of n-butyl acrylate, 11.8 g of methyl methacrylate and 0.5 g of methacrylic acid were added and the mixture was stirred. With stirring, the emulsion was heated to 80° C. and a monomer emulsion which consisted of 460 ml of water, 32 g of Emulsogen EPA 073, 12 g of the described macromonomer from example 1,440 g of n-butyl acrylate, 440 g of methyl methacrylate, 8.8 g of methacrylic acid and 2.9 g of ammonium peroxodisulfate was metered in over 4 hours. Following complete metered addition of the monomer emulsion and an after-polymerization of one hour at 80° C., the polymer dispersion was cooled to room temperature and adjusted to pH 8-9 with ammonia solution.

### Example 5

The macromonomer from example 2 was used as coemulsifier in the emulsion polymerization of vinyl acetate, n-butyl acrylate and methacrylic acid. The copolymer of vinyl acetate, n-butyl acrylate and methacrylic acid and the macromonomer from example 2 which forms in situ has, on the basis of its ambivalent structure, good emulsion-stabilizing properties.

508 ml of water were introduced into a glass flask, and 0.1 g of ®Emulsogen EP (sodium alkylsulfonate), 0.2 g of sodium metabisulfite, 31 g of a 3.75% strength ammonium peroxodisulfate solution, 22 g of vinyl acetate, 6 g of n-butyl acrylate and 0.3 g of methacrylic acid were added and the mixture was stirred. With stirring, the emulsion was heated to 80° C. and a monomer emulsion which consisted of 413 ml of water, 3.6 g of Emulsogen EP, 27 g of the described macromonomer from example 2, 858 g of vinyl acetate, 214 g of n-butyl acrylate, 10.7 g of methacrylic acid and 2.7 g of ammonium peroxodisulfate was metered in over 3 hours. The metered addition of the monomer emulsion was increased in stages so that after the first 30 minutes 10% of the monomer emulsion had been added, and in the subsequent 150 minutes the remaining 90% of the monomer emulsion had been added. Following complete metered addition of the monomer emulsion and an after-polymerization of one hour at 80° C., the polymer dispersion was cooled to room temperature.

We claim:

1. A compound of the formula (1) 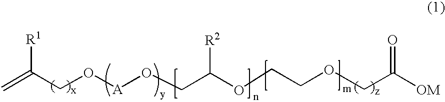
in which
R¹ is H or C₁-C₄-alkyl,
R² is methyl or ethyl,
A is an alkylene radical having 2 to 4 carbon atoms,
x is 0 or 1
y is 0 or 1
with the proviso that (x+y) is always 1
n is an integer from 0 to 100,
m is an integer from 0 to 1000,
with the proviso that (n+m) is greater than or equal to 1,
z is an integer from 1 to 6, and
M is hydrogen, an alkali metal ion or an ammonium ion.

2. A compound as claimed in claim 1, in which R¹ is a methyl or ethyl radical or hydrogen.

3. A compound as claimed in claim 1, in which R² is a methyl group.

4. A compound as claimed in claim 1, in which A is an ethylene or butylene group.

5. A compound as claimed in claim 1, in which n is a number from 2 to 50.

6. A compound as claimed in claim 1, in which m is a number from 2 to 200.

7. A compound as claimed in claim 1, in which z is a number from 2 to 4.

8. A process for the preparation of a stable polymer dispersion, said process comprising polymerizing a mixture comprising an olefinically unsaturated monomer and the compound of claim 1.

9. The process of claim 8 wherein the olefinically unsaturated monomer is selected from the group consisting of vinyl monomers, aryl-substituted olefins, olefinically unsaturated carboxylic esters; olefinically unsaturated dicarboxylic esters; olefinically unsaturated carboxylic acids and dicarboxylic acids and their sodium, potassium and ammonium salts; olefinically unsaturated sulfonic acids and phosphonic acids and their alkali metal and ammonium salts; olefinicically unsaturated amines, ammonium salts, nitrites and amides; and mixtures thereof.

10. The process of claim 8 wherein the mixture comprises 0.1 to 50 percent by weight of the compound of claim 1 based on the olefinically unsaturated monomer.

11. A process for coating a surface comprising disposing on said surface a coating comprising the compound of claim 1.

12. The process of claim 11 wherein the surface comprises textiles, leather, wood, metal, plastic and mixtures thereof.

13. The process of claim 11 wherein the coating comprises a paper size in paper and board production.

14. The process of claim 11 wherein the coating comprises a binder for pigments and fillers in printing pastes for said surfaces.
